(19) United States
(12) Patent Application Publication
(10) Pub. No.: US 2007/0064054 A1
(43) Pub. Date: Mar. 22, 2007

(54) Polyester flex circuit constructions and fabrication methods for ink-resistant flex circuits used in ink jet printing

(76) Inventors: Terry F. Hayden, Hutchinson, MN (US); Matthew P. Jones, Starbuck, MN (US); Robert E. Loftis, Maple Lake, MN (US); Daniel F. McClure, Grand Rapids, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/512,071

(22) Filed: Aug. 29, 2006

Related U.S. Application Data
(60) Provisional application No. 60/712,363, filed on Aug. 29, 2005.

(51) Int. Cl. B41J 2/05

(52) U.S. Cl. 347/59

(57) ABSTRACT

Flex circuits for use in ink jet printers. In particular, flex circuits for use in ink jet printers that include a polyester material layer supporting a plurality of metal conductors, with the polyester material being a material suitable for use in an ink environment with lower ink permeability and low moisture and ink absorption than polyimide (PI) material. The polyester layer having low ink permeability and moisture and ink absorption to prevent: catastrophic “ink shorting of conductors” failures; adhesion failures; corrosion failures by direct ink contact with the conductors; and material degradation failures that may result if any of the materials are degraded by or react with the ink. Preferably, the polyester material is polyethylene naphthalate (PEN). The polyester base layer is suitable for use in many major flex circuit construction types, including: both adhesive-less and adhesive-based circuits; and one-metal and two-metal layer circuits. Also, a method of producing an improved splice in a continuous Tab Automated Bonding (TAB) style strip of circuits, using a suitable polymer material layer, that is stronger per area than other splices.

### CROSS REFERENCE TO RELATED APPLICATION

This application claims the benefit of U.S. Provisional application having Ser. No. 60/712,363, filed Aug. 29, 2005, entitled “POLYETHYLENE NAPHTHALATE (PEN) FLEX CIRCUIT CONSTRUCTIONS AND FABRICATION METHODS FOR INK-RESISTANT FLEX CIRCUITS USED IN INK JET PRINTING,” which application is incorporated herein by reference in its entirety.

### TECHNICAL FIELD

The present invention relates to ink cartridges for ink jet printing, and more particularly to flex circuits including a polyester material layer, preferably polyethylene naphthalate (PEN), with low ink permeability and low moisture and ink absorption to prevent: catastrophic “ink shorting of conductors” failures; adhesion failures; corrosion failures by direct ink contact with the conductors; and material degradation failures that may result if any of the materials are degraded by or react with the ink.

### BACKGROUND OF THE INVENTION

The assembled sub-component or device on printers that enables ink jet printing and includes flex circuits for electronic interconnections is referred to either as a printhead or an ink cartridge, with the latter name usually associated with both the printhead and the ink reservoir. Circuitry used in printheads or ink cartridges is almost exclusively based on polyimide-based flexible circuit tape, defined as polyimide (PI) dielectric film plus adherent conductors (hereinafter referred to as “PI flex circuits”). The PI flex circuits are used primarily to meet the following main application requirements: bending (flex to install application); die attachment (e.g., wire bonding—ball, stitch and wedge bonding, ultrasonic, thermosonic bonding, thermo-compression bonding, laser welding, conductive adhesive bonding, TAB or tape bonding); adhesive attachment to the cartridge (e.g., lamination, elevated temperature curing); high dimensional stability with elevated temperature processing; and chemical inertness and compatibility with ink.

Current commercially available PI flex circuits for print head environments rely on PI as an established, acceptable base flexible substrate. Reasons why PI was selected include its flexibility, its ability to be chemically patterned for backside access, the fine pitch geometry and other design requirements, and its ability to withstand the temperatures of processing for the print head environment and the temperatures experienced during print head operation over its life time. During flex circuit manufacturing, the PI substrate experiences temperatures of between 100 and 160 C. for anywhere between relatively short periods (seconds to minutes) to longer periods (hours) (see PI column of comparative information in Table 1 below in the Detailed Description section; note: solder reflow is not usually required, but is noted as an example of a short duration, high temperature process). During ink jet printing operation, the integrated circuit (IC) will reach intermittent localized temperatures required to vaporize the ink of around or above 100 C. So, the flex circuits experience relatively higher temperatures during manufacturing than during ink jet printer operation. PI is considered acceptable for use in the print head environment as it has a glass transition temperature (Tg) of 350 to 380 C. and an operating temperature of 200 C. (see comparative information in Table 2 below in Detailed Description section). Polymers having a Tg around 100 C. or below, however, are considered unacceptable.

Based upon the acceptability of PI as a flex circuit substrate for use within a print head environment, other of the factors noted above have become important aspects of further developments of flex circuits suitable for a print head. Many different manners of attaching ICs, printheads, adhesives, coatings, metal conductors, etc. to the substrate have been developed for performance aspects and manufacturability. Recent developments have addressed the effects of the liquid ink, in particular, on the conductive metal traces, in an attempt to obtain desired performance of the conductors. The conductors are also becoming thinner and narrower for spacing aspects.

U.S. Pat. No. 5,442,386 (hereinafter “the '386 patent”) describes a print head or cartridge assembly construction for preventing ink shorting of metal conductors. The patent provides a structure and method to try to avoid ink interactions with the conductive metal parts of the circuitry. It is based on PI flex circuits primarily including metal conductors and a PI layer comprising Kapton™ or Upilex™ film, which are polyimide materials for providing a layer to protect against direct ink interaction from one side of the metal conductors.

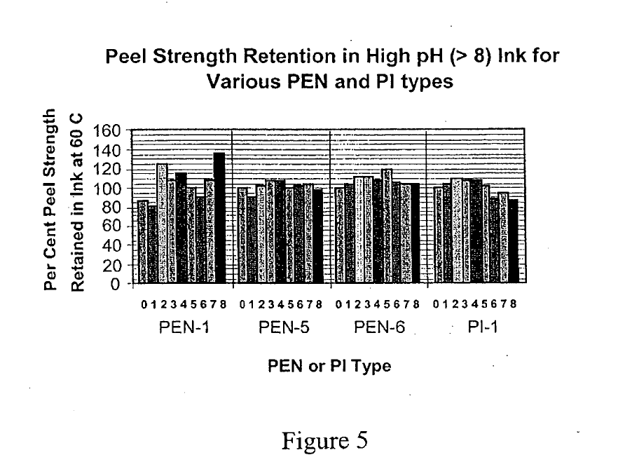

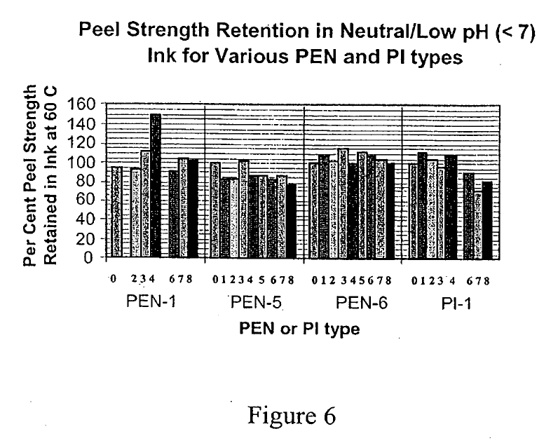

FIGS. 5 and 6 of the '386 patent illustrate different types of attachments and interfaces of adhesives, coatings, etc. with the flex circuit that are made during elevated temperature manufacturing processing to avoid ink egress, which appear in the prior art (the '386 patent, in particular). The top portion of FIG. 5 is a flex circuit subassembly (with adhesive containing layer 67 already shown as attached to the flex circuit), which is further assembled by attachment of another adhesive 90, contained in the bottom portion of FIG. 5, to the print head structure shown in FIG. 6.

The '386 patent recognizes the potential effects of ink exposure to the metal conductors and discloses the reliance on the PI layer for protecting the conductors from one side. In particular, the PI layer 58 protects the conductors from the direction that liquid ink exposure is greatest based upon ink cartridge operation (from above the PI layer 58 as illustrated in FIGS. 5 and 6).

The '386 patent's flex circuit (comprising minimally layers 58 and 72) is considered to be an adhesive-less (or 2-layer, e.g., direct-metallized, sputtering without adhesive to hold the copper traces to the) PI flex circuit. Adhesive-less flex is a commonly used commercial type of flex tape that is supplied by 3M Company of St. Paul, Minn., and 3M is the only company listed as an example of a flex circuit supplier in the '386 patent. This is in contrast to other “adhesive-based” or 3-layer PI flex circuits, in which the metal circuit layer is attached to the PI dielectric with an adhesive layer in between.

In the '386 patent, the metal traces formed on the PI are protected almost wholly by the insulating PI film layer of the flex circuit on the one side facing the ink environment and by an “insulator film” (a coverlayer 67) on the other side of the flex circuit onto which the printhead cartridge is mounted. The preferred embodiment of the “insulator film” is described as a complicated, 3-layer structure (layer 67 equals layers 158, 154 and 156 in FIGS. 13a-d) that is laminated to the flex circuit to cover most of the conductors 72. The 3-layer structure is described as comprising: an adhesive (that attaches to the conductor and substrate portions of the flex circuitry); a polyethylene terephthalate (PET) polyester layer (as a middle layer); and another adhesive (that attaches to the main body of the print cartridge).

Features, such as an opening, are patterned in the PI layer 58 (the example process stated in the '386 patent is laser ablation) and through the 3-layer insulator film 67 (a punching patterning method is described) to allow for spanning certain conductor traces so that they are partially exposed for IC bonding. After IC bonding, encapsulation of the remaining, uncovered areas of metal conductors with other insulating coatings (e.g., “adhesive beads,” “adhesives,” “encapsulant beads”) is used to avoid any direct contact of the ink to the circuitry, which may flow in the vicinity of the conductors.

The important “insulator film” (or coverlayer) properties are summarized in the '386 patent as: material handling ease; adhesion to PI tape; adhesion to print head cartridge; and, fluidic sealing of conductors from the ink. The PET layer has the following properties, which contribute to why the 3-layer insulator film is the preferred embodiment in the '386 patent: it has better structural integrity as compared with the two adhesives in the 3-layer structure, resulting in handling ease (e.g., ease in the punching patterning method, keeps structural integrity while adhesives can be softened at higher temperatures during bonding operations); it has or develops no large holes or voids during processing, such as other materials like hot melts might develop, which would allow for ink flow through the voids to reach the conductors; and, it has ability to withstand moderate temperatures (another advantage over “hot melts”).

Besides having a 3-layer insulating film assembled separately to flex circuits such as in the '386 patent, flex circuits with an adherent cover coat or coverlayer over the conductors (e.g., the coverlayer takes the functional place of layers 158, adhesive, and 154, structural, hole-free layer in FIGS. 13b-d) can be supplied for assembly. A separate adhesive (like layer 156) can be used to attach it to the other side of the assembly. One example of suitable cover coat material is the subject of Japanese published patent application no. HEI 10[1998]-158582 describing a “Protective Coating and Use of Liquid Thereof for Ink Cartridges.”

In addition to adhesive-less PI based circuits, TAB-type circuits (or tape-automated bonding “tapes”) based on adhesive-based PI are appropriate for some loosely toleranced printer flex circuit designs. In a typical TAB process the adhesive and PI are patterned together by use of a metal die or other method, then after lamination of metal (usually copper) to the adhesive side, the metal is patterned (usually by chemical etching).

The use of a wide variety of possible ink materials have been developed for ink jet use including the use of solvents such as ionic compounds (e.g., high, neutral and low pH, see patents: Japanese Kokoku Patent No. 3097771, U.S. Pat. Nos. 4,853,037, 4,791,165 and 4,786,327, European Patent No. 259001, and U.S. Pat. Nos. 4,694,302, 5,286,286, 5,169,438, 5,223,026, 5,429,860, 5.439,517, 5,421,871, 5,370,730, 5,165,968, 5,000,786 and 4,990,186). Solvents within such inks place severe constraints on the choice of materials for both the flex circuit base material and any insulator film because it is important that the base materials will not be dissolved by the ink. It is desirable to prevent ink from interacting with the conductor traces in order to attain long print head life. The above-noted list of reference patents disclosing ink materials is set out in Japanese published patent application (Patent Journal (A) Kokai Patent Application no. HEI 10[1998]-158582).

In the '386 patent, ink “shorting” mechanisms are not specifically described, but the ionic or polar nature of inks, if present between any two adjacent conductors with different voltage potentials, might render it a conductive medium, causing some undesirable level of current to flow between the conductors resulting in electromigration, also called cathodic-anodic filament growth, CAP or dendritic growth. It is well understood that the CAF reliability issue becomes important for any flex or hardboard circuit, IC package or assembly where there is moisture degradation. Moreover, in the presence of moisture, it is known that the driving force increases with the voltage difference between conductors and with the concentration of ionic species in the region between adjacent conductors. As with the presence of moisture, similarly must be the case with liquid inks. Indeed, the '386 patent provides that future high voltage levels, faster speeds and/or de-multiplexing circuitry designs might lead to use of high current supply voltages and low current control signals to be carried by the conductors and thus result in severe rather than moderate effects of shorting on the operation of the print head.

The aggressive chemical nature of the ink might cause the following types of catastrophic “ink shorting of conductors” failures: adhesion failures (metal circuitry trace-to-PI, insulator-to-PI and trace-to-insulator); corrosion failures by direct ink contact with the conductors if not covered by flex circuit base material or other materials; and material degradation failures that may result if any of the materials are degraded by or react with the ink (e.g., dissolution). These potential failures could occur at any time during operation of an ink jet print head.

### SUMMARY OF THE INVENTION

Shortcomings of the prior art are overcome by the present invention in that a suitable substrate material for a flex circuit usable in a print head environment should be selected not only for temperature constraints but also to guard against the failure mechanisms (corrosion, electromigration, CAF, ink reaction and adhesion loss). In particular, low moisture and ink absorption and permeability are important properties of flex circuit base materials, coverlayers and cover coats for flex circuits and flex circuit assemblies used in ink cartridge applications. Each of these properties can be selected to lower the concentration of inks in the vicinity of the conductors.

As a flex circuit insulator and base material, PI is considered acceptable for print head use because of its higher heat tolerance. However, PI has limitations because of poor ink compatibility, which are believed to arise because of its higher absorption of water (thus presumably also ions present in ink aqueous, polar solutions). Certain polyesters, e.g., PET, are limited by their thermal properties (see comparative information in Table 1 below in Detailed Description section) although superior as compared with PI with respect to absorption and permeability properties. In accordance with the present invention, polyethylene naphthalate (PEN), a particular polyester, can advantageously be used as a base insulator for flex circuits because PEN, offers considerably better ink soak trace peel adhesion, low moisture absorption and other improved ink resistant properties and has lower cost than PI. Also, PEN uniquely has excellent dimensional stability and high temperature stability among currently developed polyesters required for ink cartridge assembly. PEN-based flex circuits fabricated with different methods meet the current criteria for print head use.

The present invention preferably utilizes a PEN material base layer, in contrast with an “insulating” or “sealing” material covering a PI base circuit material, because of the discovered importance of low moisture and ink permeability and absorption. Although the presence of any barrier material is helpful to avoid direct ink contact, the permeability and absorption properties of the materials are more important material properties of the base layer for performance over time. According to the present invention, PEN, or other polyesters that are known or may be developed with similar material properties, are utilized instead of PI as a flex circuit base material in ink use environments because they impede the transport of ink through it better than most PIs and they have a lower moisture absorption. Although, PEN and other polyesters are also suitable for use as coverlayers. Coverlayers have different functions than base materials for flex circuits. It is more important for the base material to have ink resistant and low ink permeability and absorption properties than the coverlayer or cover coat, because the base material faces and directly contacts the ink (see layer 58 in FIG. 6). A coverlayer can, however, benefit from having similar properties. A coverlayer does not contact the ink directly as it can be provided in contact with other adhesives and coatings and is located further in the interior of the print head assembly.

The present invention utilizes a polyester base layer (preferably PEN) suitable for use in an ink environment with lower ink permeability and lower moisture absorption than PI and is suitable for use in many major flex circuit construction types, including: both adhesive-less and adhesive-based circuits (includes TAB-type circuits); and one-metal layer and two-metal layer circuits. The preferable use of PEN also permits the use of and method of producing an improved splice that is based on a welding of the PEN material that cannot be achieved with the PI-based prior art and is stronger per area than current splices and splice methods.

One aspect of the present invention is a flex circuit for use in an ink jet printer, the flex circuit comprising a flexible substrate comprising a polyester material layer supporting a plurality of metal conductors adhered along at least a portion of a first side of the substrate, the polyester material comprising a material suitable for use in an ink environment with lower ink permeability and moisture absorption than PI material. Preferably, the polyester material of the substrate comprises PEN. Another embodiment further comprises at least one opening provided through a suitable polyester layer for providing access to at least one conductor. Yet another embodiment further comprises a metal access pad adhered on the first side of a suitable polyester substrate layer with the plurality of metal conductors, the metal access pad being accessible from a second side of a suitable polyester substrate layer through a patterned opening through the suitable polyester substrate layer, and wherein at least one metal conductor is also accessible from the second side of the suitable polyester substrate layer by way of another opening through the suitable polyester substrate layer. A further embodiment further comprises at least one metal conductor adhered along at least a portion of a second side of a suitable polyester substrate layer and that is electrically connected through a metal via extending through the suitable polyester substrate layer to at least one of the metal conductors on the first side of the suitable polyester substrate layer. Another embodiment is a flex circuit further comprising an adhesive layer between the suitable polyester substrate layer and at least one of the metal conductors for adhering them together, wherein at least one of the metal conductors may be adhered to the suitable polyester substrate layer without an adhesive layer in between.

A second aspect of the present invention is a method of making a flex circuit for use in an ink jet printer, the method comprising the steps of providing a flexible substrate including a polyester material layer and adhering a plurality of metal conductors to one surface of the substrate, wherein the polyester material is suitable for use in an ink environment with lower ink permeability and moisture absorption than PI material. Preferably, the polyester material of the substrate comprises PEN. Another embodiment further comprises the step of patterning at least one opening through the suitable polyester layer for providing access to at least one conductor. Yet another embodiment further comprises the step of adhering a metal access pad on the first side of the suitable polyester substrate layer along with the plurality of metal conductors, the metal access pad being accessible from a second side of the suitable polyester substrate layer through a first opening patterned through the suitable polyester substrate layer, and patterning a second opening through the suitable polyester substrate layer so that at least one metal conductor is also accessible from the second side of the suitable polyester substrate layer by way of the second opening. A further embodiment further comprises the step of adhering at least one metal conductor along at least a portion of a second side of the suitable polyester substrate layer and electrically connecting the metal conductor on the second side by way of a metal via extending through the opening of the suitable polyester substrate layer to at least one of the metal conductors on the first side of the suitable polyester substrate layer. Yet another embodiment further comprises the steps of providing a laminate of the suitable polyester substrate layer and an adhesive layer, patterning the laminate to provide at least one access opening through the laminate, adhering a metal layer to the suitable polyester substrate layer by way of the adhesive layer, and then patterning the metal layer to create the plurality of metal conductors. A further embodiment further comprises the step of providing an adhesive layer between the suitable polyester substrate layer and at least one of the metal conductors for adhering them together, wherein at least one of the metal conductors may be adhered to the suitable polyester substrate layer without an adhesive layer in between.

A third aspect of the present invention is a print head for use in an ink jet printer comprising a printer and an ink cartridge and a flex circuit connected electrically to the IC, the flex circuit comprising a flexible substrate comprising a polyester material layer supporting a plurality of metal conductors adhered along at least a portion of the substrate, the polyester material comprising a material suitable for use in an ink environment with lower ink permeability and moisture absorption than PI material.

A fourth aspect of the present invention is a method of joining a plurality of flex circuits together in series comprising the steps of: providing a plurality of unconnected flex circuits, each having a flexible substrate including a thermoplastic polymer material layer, wherein the thermoplastic polymer material is suitable for use in an ink environment with lower ink permeability and moisture absorption than PI material, and each flex circuit further having a plurality of metal conductors adhered to one surface of the substrate; and splicing one flex circuit to a second flex circuit by overlapping at least a portion of the first and second flex circuits together and applying heat and pressure sufficient to thermally bond the first and second flex circuits together in series. Preferably, the thermoplastic polymer material of the substrate comprises a polyester. More preferably, the thermoplastic polymer material of the substrate comprises PEN. In another embodiment, the first flex circuit is combined with one or more additional flex circuits having the thermoplastic polymer material substrate layer in common.

A fifth aspect of the present invention is a method of joining a plurality of flex circuits together in series comprising the steps of: providing a plurality of unconnected flex circuits, each having a flexible substrate including a polymer material layer, wherein the polymer material is suitable for use in an ink environment, and each flex circuit further having a plurality of metal conductors adhered to one surface of the substrate; splicing one flex circuit to a second flex circuit by overlapping at least a portion of the first and second flex circuits together and applying heat and pressure sufficient to thermally bond the first and second flex circuits together in series; and inserting a strip comprising an adhesive on the overlapped portion between the first flex circuit and the second flex circuit prior to thermally bonding the first and second flex circuits together.

### BRIEF DESCRIPTION OF THE INVENTION

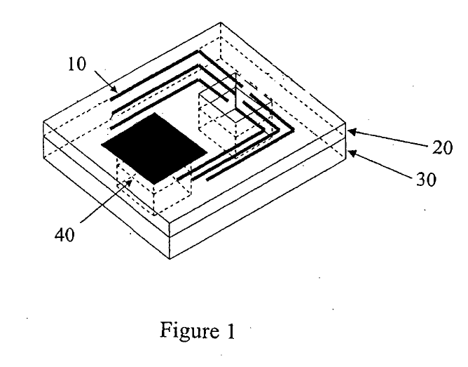

FIG. 1 shows a perspective view of a 1 ML adhesive-based PEN construction;

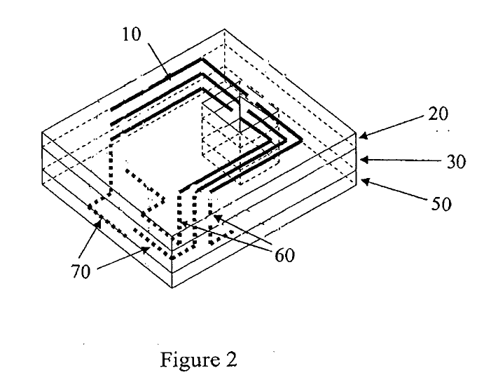

FIG. 2 shows a perspective view of a 2 ML adhesive-based PEN construction.

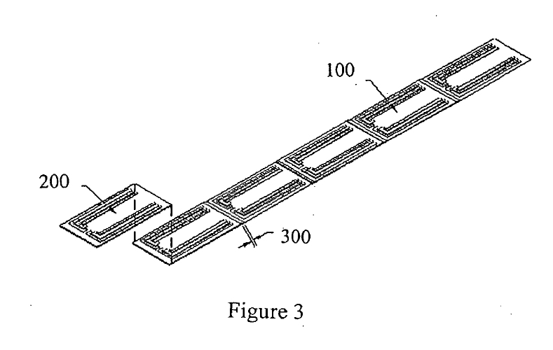

FIG. 3 shows a perspective view of a “near-invisible” splice of a tape of PEN circuits;

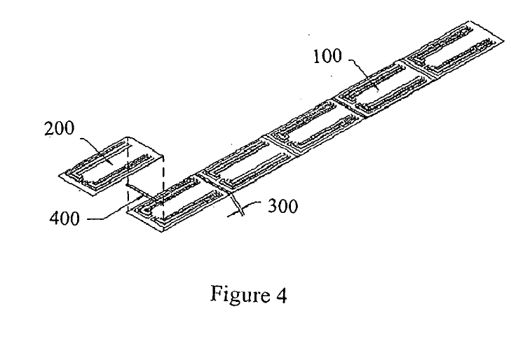

FIG. 4 shows the same perspective view of the “near-invisible” splice of FIG. 4 with the addition of a narrow film strip;

FIG. 5 shows a bar graph of percent peel strength retained in high pH (>8) ink at 60 C. at weeks 0-8 for samples of PEN and PI applied to ¼-inch wide circuit traces; and

FIG. 6 shows a bar graph of percent peel strength retained in neutral/low pH (<7) ink at 60 C. at weeks 0-8 for samples of PEN and PI applied to ¼-inch wide circuit traces.

### DETAILED DESCRIPTION OF THE INVENTION

The invention is directed to articles and methods, and involves an adhesive-based or an adhesive-less flex circuit construction, including conductors adherent to a polyester base layer, polyethylene naphthalate, hereinafter PEN. The invention is based on PEN polymer, or other known or developed polyesters with similar permeability and absorption properties, as discussed below, and preferably having low heat shrinkage suitable for dimensionally-stable flex circuitry. The following discussion is primarily directed to the use of PEN as a suitable polyester having desired properties in accordance with the present invention, but it is contemplated that other polyesters may be known and/or developed that would also be suitable. For example, polyethylene terephthalate (PET) shares similar properties suitable for an ink environment (i.e., moisture and ink permeability and absorption properties) but is not as thermally stable. However, for certain lower temperature applications, PET could function effectively. Moreover, other PET variations, or other polyesters, may be known or developed having desired ink environment properties with higher or improved thermal stability that could be used in similar low or higher temperature applications. PEN is much less expensive than PI (both adhesive-less PEN is less expensive than adhesive-less PI, and adhesive-based PEN is less expensive than adhesive-based PI). The flex circuit constructions, in accordance with the present invention, may be coated with an insulator or cover material that is strongly adherent to the PEN/adhesive or PEN, respectively. The insulator could be a dry film (e.g., cover coat, ink or coverlayer, through non-vacuum or vacuum-based lamination), a liquid screen printable, or slot-die or curtain coated insulator material. A PEN-based flex circuit can be assembled and fit in with other parts of an ink cartridge, such as that described in, for example, the prior art construction of the '386 patent (where an inferior PI-based flex circuit is used).

“Adhesive-based” or 3-layer flex circuits, as in FIG. 1, mean that the metal circuit layer is attached to the PEN with an adhesive layer in between. As shown in FIG. 1, adhesive-based flex circuits have a patterned metal circuit layer 10, an adhesive layer 20 adjacent to the metal circuit layer 10, and a layer of PEN 30 adjacent to the adhesive layer 20 and opposite the metal circuit layer 10. “Adhesive-less” or 2-layer flex circuits mean that the metal circuitry directly contacts and is adherent to the PEN without any adhesive, which is similar to the construction of adhesive-less PI flex circuits described in the '386 patent, except that PEN material is used as the base layer for superior performance for ink jet print heads. The circuit design acceptable for inkjet print heads preferably includes both frontside and backside conductor access such as facilitated by patterning the PEN and any adhesive to achieve extended conductor traces over removed or vacant dielectric regions. Examples of flex circuits in accordance with the present invention are shown in FIGS. 1 and 2. FIG. 1 shows a one-metal layer (“1 ML”) construction having one metal circuit layer 10 and backside access terminals 40. FIG. 2 shows a 2-metal layer (“2 ML”) construction with one metal layer circuit layer 10 on the upper surface of the flex circuit and a second patterned metal circuit layer 70 (indicated by the dotted lines 70 on the lower surface of the layer 50) on the lower surface of the flex circuit. The two metal circuit layers are connected with conductive metal vias (indicated by dotted lines 60 that extend through the layers 20, 30, 50) that connect the first metal circuit layer 10 to the second metal circuit layer 70, A corresponding 1 ML adhesive-less PEN construction would not include the adhesive layer in the middle, as the conductors can be directly adherent to PEN. The 2 ML adhesive-less PEN construction would not include the two adhesive layers (20 and 50 in FIG. 2) on either side of the PEN layer 30 in the middle, as the conductors can be directly adherent to PEN. In each case, the metal surfaces in the constructions can be either fully or partially gold plated or finished with other noble and bondable metals, which can include the patterned, unsupported traces meant for later IC attachment, backside access terminals for electrical contact and back, front and sides of the patterned metal features.

In the adhesive-based PEN embodiments (metal/adhesive/PEN), a metal layer of an unpatterned metal/adhesive/PEN laminate raw material roll or sheet can be chemically etched to fabricate multiple conductor traces by using a photomask and a set of process steps (photoresist-based material: application by lamination of a film or liquid coating, expose, develop and later remove after etching). A laminate raw material is preferably selected for survival of the materials and interfaces for the harsh ink environment of ink jet printing and for the high temperature of flex circuit fabrication and assembly manufacturing process steps themselves, as described previously in the Background section. Thus, metal foil and adhesive selection is preferably based on tests such as are described in the Examples including a maximization of metal adhesion in the laminate before and after exposure to ink. For the metal layer of the laminate raw material, copper foils with all three of critical adhesion, barrier, and stabilization treatments are preferred for PEN-based flex circuits in the ink jet printing application, based on successful testing of different foils with all these three treatments (see Examples 2, 3 and 5). Adhesion treatments increase the strength of the adhesive-copper bond and can comprise: (a) nodule or micro-roughening treatments that add surface area; and (b) adhesion promoter treatments like a silane coupling agent that improves chemical bonding. Barrier treatments give increased reliability in moist or high temperature environments similar to the ink printing environments (ink constituents are commonly polar in nature like water and many are water based) and typically comprise a known type of brass or zinc treatment (e.g., up to 120 nm thickness). Stabilization treatments inhibit corrosion and typically comprise the use of an oxide, chromium or chromium alloy (where Cr is in +3 valence state, typically less than 10 nm thickness). For the adhesive, high ink and moisture (being a polar compound like ink constituents) resistance have been found to be preferred properties. Moreover, based on an ordering based on ink resistance tests (see Example 3 for the description of a 60 C. soaking of parts in ink for 1000 hours) for some cover coat materials applied to PI adhesive-less flex circuits, an adhesive material designation Type L (epoxy, see IPC Spec 4204, May 2002) is expected to outperform both M (acrylic) and P (butyral phenolic) as used in adhesive-based PEN laminates. The discussion in the Example 2 section describes tests where the retention of peel strength of metal to PEN and PI base materials was measured, but in the cover coat ink resistance tests the PI flex circuits cover coated with different cover coat chemistries exhibited a ranking with respect to delamination of different cover coats; acrylic- and butyral phenolic-based cover coats delaminated much more quickly than epoxy-based ones, some of which survived after 1000 hours. Results detailed in Examples 2, 3 and 5 indicate PEN laminates with various adhesive chemistries, including modified epoxy and polyester-epoxy blends, performed successfully in different tests that evaluated ink resistance.

Moreover, based on PEN circuit fabrication with commercially available foils and laminates (JTC Flex™ silane-treated, micro roughened, foil with zinc—chromium layers, commercially available from Gould Electronics Inc., located in Chandler, Ariz., U.S.A.; PEN laminates G1910 and G1965 that use polyester-epoxy blends for adhesives (commercially available from Multek Flexible Circuits Inc., Sheldahl Technical Materials Division, located in Northfield, Minn., U.S.A.), and DuPont-Teijin Q83™, for the PEN base material, foil (commercially available from DuPont Teijin Films U.S. Limited Partnership, located in Hopewell, Va., U.S.A.) with PEN laminate GTS 5670 (commercially available from GTS Flexible Materials Ltd., located in the Berkshire, United Kingdom) that use a modified epoxy adhesive) with high metal peel strengths and peel strength retention after exposure to humidity and temperature, it is further contemplated that (a) other foils with similar micro roughening treatments, silane-coupling or other adhesion promoting treatments, zinc—chrome barrier and stabilization treatments and (b) other Type L and N adhesives, are preferable. However, the present invention is not limited to those specified foils and laminates as other types of foils with none or one or more of the above-noted treatments and adhesives with other designations can be suitable for use in PEN-based flex circuit ink jet printing applications. Also, other IPC adhesive designations (see IPC Spec 4204, May 2002), including Types R and Y, may also be acceptable without limitation, although such adhesive lamination temperature with copper foil may be limited to the softening temperature of the PEN, or similar polyester, based material. Circuits made from one source of PEN (PEN films commercially available from DuPont Teijin Films U.S. Limited Partnership located in Hopewell, Va., U.S.A.) that were annealed after being formed as a film to improve dimensional stability have been described previously (such as those commercially available from Multek Flexible Circuits Inc., Sheldahl Technical Materials Division, located in Northfield, Minn., U.S.A.). Another example of a PEN film that is commercially available is the Skynex® NX10L film, commercially available from SKC Co., Ltd. Both have been found to have about the same low ink permeability and moisture absorption compared to PI (see Example 1). However, the present invention is not intended to be limited to just those PEN film sources and PEN laminate manufacturers that were tested. For example, it is contemplated that the PEN raw film could be made and laminated by other methods and can be formed by various means (e.g., extrusion, blow molding, tubular film extrusion, etc.), providing that the films achieve sufficient dimensional stability to hold tolerances for flex circuits (preferably better than +/−0.3%, IPC).

To fabricate backside access features, a PEN material layer and adhesive may be patterned successfully with methods such as (or an appropriate combination of) laser ablation, chemical etching, plasma etching (e.g., use of oxygen or oxygen-CF4 gas mixtures), chemical and/or electrochemical cleaning and mechanical cutting or stamping operations (e.g., making use of metal dies; see also Example 4). Laser ablation of both PEN and adhesive layers sequentially in the same patterning locations is a preferred method for producing both backside access and vacant dielectric regions for unsupported metal conductors in 1 ML designs (see FIG. 1 and Example 4) and small via holes in 2 ML designs (see FIG. 2; in this case sequential layers in the stack-up of metal, adhesive, PEN, adhesive and metal in the raw material laminate could be laser ablated and cleaned). However, adhesive can also be paired either with PEN, with metal or by itself, and the layers can be patterned together or separately with an adhesive lamination step inserted at an appropriate time in the process. For example, for 1 ML designs, the PEN-adhesive can be patterned first and then attached (e.g., by lamination) to the metal. Then the metal can be patterned such as by variation on the TAB process described earlier, but where PEN replaces PI. In order to remove any adhesive by-products that may have been incompletely removed by the laser and/or plasma, chemical cleaning and microetching (e.g., with a sulfiric-based or other acid-based solution) techniques, as themselves are well known, are preferably conducted prior to any surface finishing (e.g., gold plating).

For an adhesive-less PEN construction, direct metallization can be accomplished by vacuum deposition techniques or high temperature copper foil laminations near the melting point of the PEN. Then, the metal can be patterned by additive, semi-additive or subtractive processes using a photoresist. Sputtering of metal is specifically contemplated as an effective manner to metalize PEN or other suitable polyester material as such procedure is known to be effective in metallizing PI in making adhesive-less PI in production. However, evaporation and other vacuum techniques are also believed to be possible and are expected to be usable. Example 4 below further demonstrates examples of certain foil laminations that are useable in accordance with the present invention and that suggest the ability to create similar foil laminations.

It is also contemplated that a unique, low-cost, semi-additive-based or subtractive-based process flow could progress from a raw material produced by laminating PEN directly or indirectly with adhesive (e.g., DuPont Q83™ film, commercially available from DuPont Teijin Films U.S. Limited Partnership, located in Hopewell, Va., U.S.A.) and with a thin copper foil, which has a separable interface between a thin, few-micron (e.g., 1 to 5 micron) copper layer and a thicker sacrificial copper layer that can be separated after lamination. As one specific example, it is contemplated that single-sided (4 micron or 35 micron copper/PEN, where 35 micron copper is a commonly available foil) or double-sided material (1-4 micron copper/PEN/1-4 micron copper or 35 micron copper/PEN/1-4 micron copper) could uniquely be produced for the 1 ML and 2 ML constructions, respectively (see FIGS. 1 and 2). In contrast, commercial raw material with PI (e.g., Kapton™ H film commercially available from E.I. du Pont de Nemours and Company, located in Wilmington, Del., U.S.A) is produced from vacuum-metallization or by casting PI on metal foil. Analogous to the cast PI process, it is contemplated that PEN or other raw material can be produced by depositing from solution or other means (e.g., casting) PEN polyester on metal foil as a viable source of polyester (PEN)/metal substrates for circuitizing into 1 ML flex circuits useful for ink jet printing.

For either vacuum-based or lamination-based processes, a tie coat or tie layer may be removed by chemical means. For sputtering, a chrome tie coat can be utilized (as in the Examples below), but other sputtered tie coats like NiCr, monel and others are contemplated, which may have better corrosion resistance to inks.

For lamination-based processes for making adhesive-less based PEN circuits, copper foils with adhesion, barrier and stabilization treatments (as discussed above with regard to adhesive-based PEN) are desirable for moisture-resistance and ink resistance, as discussed above for similar reasons as described for adhesive-based PEN applications. Thus, preferred foils with micro roughening treatments, silane-coupling or other adhesion promoting treatments, zinc—chrome barrier (for reliability in moist environments) and stabilization (or antioxidation) treatments (like those provided by JTC Flex™ foil, commercially available from Gould Electronics Inc.) are preferably combined with dimensionally stable PEN or other polyester films (like DuPont-Teijin Q83™ film, commercially available from DuPont Teijin Films U.S. Limited Partnership, located in Hopewell, Va., U.S.A.) in order to achieve effective metal peel strengths and peel strength retention after exposure to inks.

The same or a combination of some of the same patterning methods described above in describing adhesive-based PEN can be used for PEN alone (e.g., laser ablation, plasma ashing, chemical cleaning and mechanical patterning), but also chemical removal of PEN material has been demonstrated. As with the adhesive-based construction, laser ablation is a proven and preferred method for producing small (e.g., 25 to 75 micron diameter) via holes to conserve area in 2 ML designs, but even chemical and mechanical (e.g. punching) removal of larger holes on adhesive-less PEN for vias are contemplated.

Whereas chemical removal of both PEN and adhesive is difficult because two chemistries are likely needed to etch two different materials, chemical etching of PEN at reasonable reaction rates can be accomplished by controlled cleavage of the PEN polymer chain in unmasked areas exposed to chemical reactants in conjunction with either a backside metal (preferred, or possibly a photoresist) mask. A 1 ML adhesive-less PEN construction can be fabricated from a double-sided metallized raw material with the frontside patterned for circuitry and the backside patterned as a sacrificial metal mask. PEN is believed to be unzipped into soluble, single, naphthalate-ester fragments with most relatively non-volatile, water-soluble organics with a single-functional OH group and other functional group(s) to increase the boiling point (called “modified simple alcohols” ), but not—COOH acid groups, because of the interchange reaction pattern of polyesters is by alcoholysis and not by acid groups (see P. J. Flory, “Chapter 3, Condensation Polymerization,” in Principals of Polymer Chemistry, Cornell University Press, Ithaca, N.Y., pp. 69-105, incorporated herein by reference). The modified simple alcohol (e.g., mono ethanol amine (MEA)) should be selected to have a moderate boiling point so as not to be removed during processing around the boiling point of water where reasonable reaction rates are achieved (thus MEA, a modified alcohol, is preferred above ethanol or a propanol). Larger alcohols (e.g., butanols and pentanols) have higher boiling points, but would not be preferred because of lower solubility of themselves and the corresponding naphthalate ester product in aqueous solutions. Multifinctional alcohols (or glycols) may also unzip the polymer and have the advantage of a greater number of reactant OH groups and a greater solubility in water, but may be subject to undesirable side polymerization reactions. The solubility of the naphthalate-ester product of the cleavage reaction is also important to the choice of the modified simple alcohol.

Chemical etch rate can be increased to useful levels by catalysis in either basic solutions (e.g., NaOH or KOH) or likely also in acidic solutions (e.g., sulfuric-based or other), consistent with polyester acid-base-catalyzed, trans-esterification mechanisms relying on “the polar nature of the carbon-oxygen double bond and the ability of the carbonyl oxygen atom to assume a formal negative charge” (see M. P. Stevens, “Chapter 10: Polyesters” in Polymer Chemistry: An Introduction, Addison-Wesley, Reading, Mass., pp. 251-275, also incorporated herein by reference). As it is understood that a high PEN etch rate can be achieved in highly basic solutions with certain concentrations of MEA/KOH and MEA/NaOH, “presumably increasing the nucleophilicity of the alcohol by formation of the alkoxide anion” (see Stevens' description of transestification mechanisms of the base catalyzed reaction), it is further believed that acid catalysts with MEA or other modified simple alcohols will “coordinate the carbonyl oxygen and thus enhance the electrophilic character of the carbonyl carbon” (see Stevens' description of transestification mechanisms of the acid catalyzed reaction).

A preferred PEN chemical removal method to produce well defined, angled PEN sidewalls can be based upon a circuit processing technique utilizing double-sided metal covering PEN and by using backside metal patterning to define a metal mask that can be used in a PEN patterning removal step. Initially, frontside circuitry and backside mask patterns can be etched at the same time using a photoresist method. The frontside circuitry can be protected with a blanket exposure of photoresist during a patterned removal of PEN based on the backside mask pattern. The backside metal thickness is preferably thin and the metallization method used is preferably a low cost method so as to minimize both the cost of the etching step to remove the sacrificial metal and the overall processing costs. Lamination of thin metal foils to PEN can be effectively accomplished by using thin, separable copper foil (e.g., Olin Corporation, Brass Division's (located in East Alton, Ill., U.S.A.) CopperBond® XTF™ foil; also, see previous discussion wherein a thin foil portion can remain after separating an interface after lamination) and such laminations are expected to be less expensive than second-side vacuum metallization processes that are currently used on PI (e.g., 25 micron copper/tie coat/PI/tie coat/4 micron copper adhesive-less raw material as is commonly used).

A further discussion regarding the fabrication methods described and suggested above and superior ink resistance of PEN- or other polyester-based flex circuits versus PI-based flex circuits is found in the Examples section below.

Table 1, below, shows a comparison of polyesters including PET and PEN to PI as to temperature suitability for making flex circuits usable for ink jet printing. While PET as currently available is generally less than acceptable, primarily due to temperature exposures of manufacturing, PEN is highly acceptable for temperature criteria as illustrated in comparison to PI, while being significantly better than PI with respect to permeability and absorption (as detailed below). With the advent of improved or different manufacturing steps that may include lower temperature processing, PET may also be acceptable for processing as flex circuits with superior permeability and absorption properties as compared with PI (also detailed below). Likewise, other polyesters may be known or developed with effective properties for processing and environmental usage with superior permeability and absorption properties as compared with PI for ink jet applications.

TABLE 1
Common Thermal Excursions for Circuits and Acceptability Expected for Circuit Dielectric
Material Based on Physical Properties of Select Dielectrics.

| | Dielectric Material | | |
|---|---|---|---|
| | PET | PEN | PI |
| Cover Coat Cure | Not acceptable | Acceptable | Acceptable |
| 130 C.-160 C., 10 to 90 minutes | over whole range | over whole range | over whole range |
| Assembly (adhesive, encapsulants, cover lays, | Acceptable in lower | Acceptable | Acceptable |
| other coatings) 110 C.-160 C., 10 to 60 minutes, | range | over whole range | over whole range |
| IC attach, 150 C.-160 C. (typical), but also | Acceptable in lower | Acceptable over | Acceptable |
| above and below, seconds to 10 s of seconds | range | whole range except | over whole range |
| | | high extremes | |
| Peel After Solder Float (% retension) | Fail | 8.5 lbs/in | 12 lbs/in |
| (IPC TM 650 #2.4.9, method D, 204 C. for 5 sec) | | (100%) | (100%) |

See Table 2 for comparison of PI, PEN and PET properties

The ability of PEN-based circuits, in particular, to pass the short duration solder float test (see Table 1: test performed for 5 seconds at 204 C.) with minimal impact on peel retention (percent of the force retained after versus before solder exposure), demonstrates PEN's suitability similar to that of PI along with PEN's superiority over PET with respect to thermal processing. Moreover, this ability also evidences PEN's adequacy in surviving many short to medium duration (seconds to tens of seconds at least) manufacturing temperature environments during printer flex circuit assembly that are above the flex circuit's continuous use operating temperature (above 160 C.). The use of PEN-based flex circuits would, for example, potentially exclude only the most extreme IC attach/bonding processing conditions (bonding temperature extremes were reported to reach above 300 C. in G. Harman's review of the many potentially usable methods that are mentioned above in the Background section for IC attachment (Wire Bonding in Microelectronics: Materials. Processes, Reliability and Yield, McGraw-Hill, N. Y., 2^{nd} ed., 1997). As such, those extreme temperature techniques can easily be avoided by selection among the many other, non-extreme processes. Indeed for the IC attach step, the base material usually does not come into contact with the heat source, except indirectly by conduction through unsupported traces, and an energy pulse is usually short (order of microseconds to milliseconds), thus the base material itself usually reaches temperatures much lower than the actual bonding temperatures. Thus, higher temperature resistance of PI as compared to that of PEN is an unnecessary property, and PEN-based circuits and other high temperature resistant polyesters (albeit those with higher resistance than PET as tested) have sufficient temperature resistance to withstand current thermal processing steps.

Table 2 below provides a comparison of certain physical properties of PET, PEN and PI. These properties are relevant and useful with regard to the Examples below, in particular with regard to Example 1. Also, the Table provides, for example, that the water absorption percentage of PEN is much lower than that for PI. Additionally, the water absorption percentage for PET is close to that for PEN, indicating that other polyesters, such as PET, are also suitable materials for the present inventive flex circuits.

TABLE 2
Physical Property Comparisons of Flex Circuit Dielectric Materials.

| | | Dielectric Material | | |
|---|---|---|---|---|
| Physical Property | Unit of Measure | PET | PEN | PI |
| Thickness | mils | 1 to 5 | 1 to 5 | 1 to 5 |
| Thermal Shrinkage | % | 0.2 to 1.5 | 0.08 to 0.5 | 0.03 to 0.18 |
| {IPC TM 650, 2.2.4A, 150 C., 30 min} | | | | |
| Coefficient of Humidity Expansion | ppm/% RH | 10-11 | 10-11 | 5-16 |
| Water Permeability | g/m²/day | 21-26 | 6-10 | 4-28 |
| {JIS K 7129 method B} | | | | |
| Water Absorption | % | 0.4-0.8 | 0.3-0.6 | 1.8-3.7 |
| {ASTM D570-01, 23 C., 24 hrs} | | | | |
| Oxygen Permeability | cc/m²/day | 55 | 21 | 4-114 |
| {ASTM D1434} | | | | |
| Melting Point | C | 260-264 | 269-272 | NA |
| Glass Transition Temperature (Tg) | C | 69-78 | 120-122 | 350-380 |
| {IPC TM 650 2.4.24.2, DMA method} | | | | |
| Maximum Continous Operating Temperature | C | 100-105 | 160 | 200 |
| {UL7466} | | | | |
| Alkali Resistance, weight loss after 5minutes | % | nil | nil | 4-26 |
| in 1N KOH at 40 C. | | | | |

In accordance with the present invention, a dyed adhesive can be used with adhesive-based PEN for creating flex circuits for the purposes of increased process throughputs (e.g., laser ablation rate) and aesthetic needs. A dyed adhesive having a color that corresponds to the wavelength of the laser, results in the laser ablation process more effectively removing material more quickly. In the Examples below, a dye was added to at least one type of adhesive used, and it did not negatively affect performance of the adhesive during the ink resistance testing. From information as shown in Examples 2, 3 and 5, the use of dye within adhesive is believed to be suitable for use in flex circuits for ink jet printer applications.

Unlike PI as used in prior art adhesive-less based or adhesive-based flex circuit (having trade names Kapton™ E-film (commercially available from E. I. du Pont de Nemours and Company of Wilmington, Del., U.S.A), and Upilex™ film (commercially available from Ube Film Ltd., located in Japan)), PEN is a thermoplastic, as contrasted with PI, which is a thermoset material. Thus, upon localized heating with pressure, PEN and other similar thermoplastic polyesters can be joined or welded with itself to make strong splices in reel format. Splicing is useful after cutting and separating out defective circuits in a reel so as to join together only good parts in a reel or joining short reel sections of parts (e.g., panels cut into reel strips) together in larger reels. Both PI and PEN circuits can be spliced together with separate adhesive and tape, but PEN circuits can be spliced together more simply without use of extra material, cost and handling by heating above the melt temperature of PEN and making a PEN-to-PEN joint. Compared to standard splice methods, the melted joint is relatively invisible (magnified inspection would be needed to see if splice is present) and stronger per unit area, making for less circuit area waste, an advantage to suppliers and customers (handlers) of the circuits. The advantage of this heated splice is not limited in scope to printer flex circuit applications, and can be applied to all circuit configurations manufactured from PEN or similar thermoplastic polymer or polyester material.

Current methods used to splice TAB (Tab Automated Bonding) and reel-to-reel circuits typically involve the formation of an adhesive patch that consists of an overlay of adhesive backed by a non-adhesive polymer film support material. For sufficient bond strength, significant extra tape patch areas on parts are frequently required to provide a sufficiently strong adhesive bond to survive handling processes in manufacturing that expose the reel to various stresses (e.g., high impact forces of short duration to continuous and cycling stresses, temperature stresses). This type of patch can thus extend beyond defective parts on the reel meant to be removed and render otherwise good adjacent parts to be “defective” parts as part of the splicing procedure.

In contrast, a “near-invisible” splice (FIG. 3) requires less area and no extra material and offers the possibility of eliminating the destruction of good parts to make a splice. As compared to typical tape splices of 0.375 to 0.750 inch widths, splices of similar and sufficient strength can be made in an area approximately 0.040 inch wide. More or less area could be used depending on the strength requirements of a splice.

FIG. 3 shows a continuous TAB style strip of circuits 100 with one individual circuit 200 being positioned to be spliced to the strip in accordance with the present invention. A successfully welded splice joint is shown at 300, wherein the splice joint is fully contained between adjacent circuits 100 without adverse effect.

Splices are commonly made in sections of tape containing circuits where defects occur. In prior art splicing techniques utilizing tape patches, a defective section of circuits is cut out and removed while leaving a portion of a defective part at each end to be rejoined with the tape patch. This method leaves a defective part to be used as the joining member of the strip. In some cases, where good parts are dispersed within bad parts, manufacturers often cut out the good with the bad to reduce the quantity of splices. The “near-invisible” splice technique of the present invention does not result in any lost parts and therefore results in higher yield since no good parts are required to be removed or destroyed.

When producing reel-to-reel and TAB products with prior art technology, manufacturers typically allow a set number of defects to remain in the reel to reduce the quantity of splices. With “near-invisible” splicing, reels can be produced with 100% good parts without regard to the number of splices, thereby the customer is provided with an exact number of good parts per length of material.

Producing reel-to-reel and TAB products requires expensive specialized equipment to process long rolls of material through the many steps required for circuit manufacturing. Manufacturers that produce circuits in panel form may find the cost of equipment prohibitive and may be unable to supply customers that require product to be delivered in continuous reel form. A further advantage of the “near-invisible” splice is that the length of the base raw material has no bearing on the length of the final TAB or reel-to-reel product being produced. Circuits can be produced in panel form comprising either individual parts or individual short strips of parts that can be joined together to form a continuous length of product. The joining operation can be done on a single piece of equipment at the final stage of the production process thereby reducing the cost of equipment to the manufacturer to enter the reel-to-reel and TAB market. These offer manufacturing cost and throughput and others technological advantages over manufacturers solely using reel-to-reel equipment. Moreover, use of an adhesive strip as detailed in FIG. 4 extends the benefit of this splicing method to other types of flex circuits, including those fabricated with PI and PEN.

Based on experiences with pressure sensitive tape adhesion, we suspect that splices requiring additional strength beyond that obtained with a PEN to PEN, or similar thermoplastic polymer or polyester, heated joint may be made stronger with the addition of a third component inserted between the PEN films at the joint. This third layer could be a narrow film strip (shown as 400 in FIG. 4) of pressure sensitive adhesive, a hot melt or heat re-flow adhesive material or one of several other bonding techniques suitable for joining films together. The design of this type of modified splice joint is expected to enjoy all the previously detailed benefits of sufficient strength in a small area that the narrow welded splice joint width of the “near-invisible” splice allows. And, can be extended to non-thermoplastic flex circuits material (e.g., polyimide).

### EXAMPLES

1. Diffusion of generic inks through polyimide (PI), polyethylene terephthalate (PET), and polyethylene naphthalate (PEN) base material films.

Inks that are typically used in ink jet printers are polar liquids comprised of a mixture of solvents, pigments, dyes, and/or water. Preferred flex circuit substrates, in accordance with the present invention, for ink jet printing are expected to have lower ink permeability to avoid ink egress through the film into the vicinity of the metal conductors. Ink chemical make-ups vary widely and, as a result, each will have its own permeability through the different substrate materials. Ink permeability can be measured empirically or can be estimated from known water and oxygen permeability and absorption values as set out below in Table 3. PI, PET, and PEN are substrate or base film materials. Table 3 compares some important physical properties of the three materials as they relate to permeability of the substrates.

TABLE 3
Substrate Properties of PI, PET and PEN Related to Ink Permeability
and Absorption.

| | Range of values for | | |
|---|---|---|---|
| | PI (in parentheses: | | Value for |
| | specific values for certain | | PEN |
| | Kapton products, | | (specifically |
| | available from E.U. du | Value | Teonex Q83, |
| Physical | Pont de Nemours and | for | avail. From |
| Property | Company) | PET | DuPont-Teijin) |
| H2O | 4-28 (22 for Kapton | 21-26 | 9.5 |
| Permeability | HN, 5 for Kapton E) | | |
| (g/m²/day) | | | |
| H₂O Absorption | 1.8-3.7 (3 for Kapton | 0.4-0.8 | 0.3 |
| (weight %) | HN, 1.8 for Kapton E) | | |
| O₂ Index (%) | 4-114 (38 for Kapton | 18 | 22 |
| | HN) | | |

Absorption of polar substances like water in substrates can provide a model to aid understanding about the suspected affinity and ease of incorporation of other polar substances (like ink) inside substrates. This may also predict the ease of transport of polar substances through substrates. Oxygen permeability is a common gage that can be used to rank the general diffusivity of small gas molecules through different substrates. This can also be a valuable aid when theoretically estimating permeability of larger molecules, such as ink constituents, through different substrates.

As can be seen in Table 3, the oxygen permeability values for PEN and PET, another polyester, are generally less than those for PI.

It is understood that pH differences generally increase reactivity as the pH moves away from neutral (7 pH). Some PIs are known to be prone to chemical etching in strong base (e.g., Kapton E is known for having high etch rates in KOH and NaOH). That is, such etchable PI will have high permeability and reactivity for any inks with pH approaching 14. Polyesters, on the other hand, are not known to be chemically etched with strong base solutions. As such, such polyesters as PEN and PET should have less variability to expected values of permeability than PI across inks of different pH values.

The permeability of two representative inks (in a range of high and neutral/low pH) were measured through various PEN, PI and PET substrate base films, which are suitable for fabrication into dimensionally stable flex circuitry, by monitoring ink weight-loss curves at 60 deg C. Exposure to inks with different pHs for long periods of time (e.g., weeks) at temperatures of circa 60 deg C. is a typical test procedure used to accelerate failures in a print head environment (e.g., previously referenced Japanese patent HEI 10[1998]-158582). For these permeability tests, ink was placed into metal cups with 6 cm diameter circular openings that were sealed with PI, PET, or PEN 50 micron thick “membrane” films from different manufacturers. Weight loss was monitored versus time at intervals between 24 to 150 hours up to 870 or 1000 hours. Linear regression, through which high correlation coefficients (in all cases greater than 99.5%) were obtained, was used to determine best fit slopes for each film experiment, then slopes were averaged for the different film types.

Both PEN films and one PET film tested had consistently lower ink permeability than most PIs (see Table 4 below), thus indicating superior or at least approximately equivalent resistance to ink transport than the PI films. Thus, PEN and other polyesters with low permeability provide advantageous properties for use with ink jet printer cartridges, as ink is not able to diffuse as quickly through PEN, PET or similar polyesters as through most PIs.

TABLE 4
Permeability of Representative Inks of Different pHs through PEN,
PI and PET films.

| | | | Permeability (g/m2- |
|---|---|---|---|
| | Different materials | Permeability (g/m2- | day) of Neutral/Low |
| | manufacturers' | day) of High pH | pH (pH < or equal |
| Base | thermally stabilized | (pH >8) Ink | to 7) Ink through |
| film | flexible films | through the films | films |
| PEN | 1 | 4.40 | 8.32 |
| | 2 | 4.43 | 6.23 |
| PI | 1 | 6.39 | 7.60 |
| | 2 | 26.7 | 25.3 |
| | 3 | 23.1 | 24.1 |
| PET | 1 | 9.6 | 10.1 |

PEN 1, in Table 4 above, comprises a Teonex® Q83™ film, commercially available from DuPont-Teijin Films U.S Limited Partnership, located in Hopewell, Va., U.S.A. PEN 2 comprises a Skynex® NX10L film, commercially available from SKC Co., Ltd in Seoul, Korea. PI 1 comprises a Kapton® 200E™ film, commercially available from E. I. du Pont de Nemours and Company, located in Wilmington, Del., U.S.A. PI 2 comprises a Kapton® 200HN™ film, also commercially available from E. I. du Pont De Nemours and Company, located in Wilmington, Del., U.S.A. PI 3 comprises a Apical® 200NP™ film, commercially available from Kaneka High Tech Materials, Inc. of Japan. And, PET 1 comprises a Skyrol® AH82L film, commercially available from SKC Co., Ltd in Seoul, Korea. The high pH ink listed in the table is Encad K208163-4GS ink having a pH of about 8.56, commercially available from Big Systems, Inc. of Butler, Wis., U.S.A. The low pH ink is Encad Y208163-3 GS ink having a pH of about 6.8, also commercially available from Big Systems, Inc. of Butler, Wis.

The measurements shown in Table 4 are consistent with expected ink permeability rankings between the three film types based upon the properties set out in Table 3. PEN, in particular, is noted as being a half to full order of magnitude less permeable than most polyimides as suggested by the moisture and gas permeability values. The PET film tested that had even lower permeability than expected (about 10 for ink versus 21-26 for water permeability), which means that PET is also effective for ink jet printer flex circuit base substrate film. Moisture absorption effects on the adhesion of metal, adhesives and other laminate constituents and cover coat adhesion properties to PEN and PI are also discussed in Examples 2 and 3 below.

2. Adhesion retention of metal to ipolvimide (PI) versus polyethylene naphthalate (PEN) base materials upon exposure to representative inks.

As supported in Example 1 above, PEN and other polyesters have been found to be less permeable to representative inks than many PIs. Excessive permeability can be detrimental to metal adhesion in flexible circuit applications. Once the ink has diffused into the metal-to-polymer interface, according to its concentration levels, it can attack the metal directly or weaken and break metal-to-polymer bonds or cause dendritic growth (as discussed above in the Background section about ink properties and shorting and other failure mechanisms). It is, therefore, advantageous to use a substrate material with a lower permeability, as it will yield greater adhesion retention over time. However, it is also critical to assure the ink resistance of the metal-to-substrate bond when ink, even in low concentration, comes into contact with it after diffusing through the substrate. The purpose of Example 2 is, therefore, to quantify the resistance of the metal-to-substrate bond to different inks and to different ink exposure times on different types of PEN and PI flex test circuits with 1 ounce copper thickness, which is used in most printer flex designs. The effect of moisture absorption properties (mentioned in Example 1) on metal adhesion to PEN and PI circuits is also discussed in this Example.

Bare circuits for two types of circuit designs were fabricated in order to measure adhesion retention using two different methods. In the first method, ¼-inch (6.35 mm) wide copper traces were patterned from PEN and PI laminates, and a 90 degree peel strength of the trace from the substrate was directly measured as a function of ink exposure time. In the second method, much finer width (75-100 micron) copper traces were patterned from the same PEN and PI laminates, and circuits were inspected for delamination as a function of ink exposure time. The first method had the advantage of quantifying the adhesion (peel strength) retention of the metal from the base substrate film material directly, but the second method had the advantage of the test circuits having a more representative product design, as the final product typically has minimum trace width dimensions ranging from 50 to 100 microns. With both circuit designs, traces were formed by aqueous etching in CuCl₂ (cupric chloride) using photoresist masking method (application, expose, aqueous develop of resist mask, stripping after etching) from initial copper-on-polymer “laminates.” The term “laminates” includes both adhesive-based and adhesive-less materials, that is copper deposition either through lamination or sputtering/plating operations. Samples made from different circuit and material types were peel tested for initial adhesion. Additional samples were placed into glass jars filled with representative inks (the same inks as used in Example 1, having different pH values) in an oven at 60 C., the same standard temperature used to accelerate failures relating to ink exposures in Example 1. Samples were removed from the jars at approximately weekly intervals for up to 1000 hours and tested for adhesion retention over time.

With the ¼-inch trace circuits, peel force versus time were measured with a 100 pound load cell mounted on a “Chatillon” peel test fixture with the substrate attached PEN or PI side face down to a German wheel, while the metal traces (separated for a short length before the peel force was monitored) were held in grips anchored to a crossbar, and were individually pulled at 2 in/min crosshead speed. Unless otherwise indicated, the failure mode was either an adhesive failure of the copper-adhesive or adhesive-base film interfaces or a cohesive failure in either the adhesive or base film layer for the adhesive based circuits or either an adhesive failure of the copper-tie layer or tie layer-base film interfaces or a cohesive failure in either the tie layer or base film layer for the adhesive-less circuits. A failure mode between the base material layer and the German wheel (e.g., in the bonding adhesive) was sometimes observed, which indicated a much lower peel test value than any of the common failures described above, which failure mode was unacceptable as not representing the true materials-based peel strength and thus was not included in this analysis.

For the fine-lined circuits, three samples per circuit material set were used and they were placed back in ink for additional ink exposures and re-inspections, since it was a non-destructive test. Fine-lined circuits were considered to have failed when traces (or cover coat for cover-coated circuits in Example 3) became delaminated completely from the polymer substrate during the inspections. In all cases, samples were removed from the ink and washed with deionized water at circa 20 deg C. prior to inspection or peel testing. For peel testing, a destructive test, three samples were used for each week of ink exposure condition and failure modes were verified on the peeled samples after the test.

FIG. 5 is a bar graph showing the results of percent peel strength retained in high pH (>8) ink at 60 C at weeks 0-8 for samples of PEN and PI applied to ¼-inch wide circuit traces. FIG. 6 is a bar graph showing the results of percent peel strength retained in neutral/low pH (<7) ink at 60 C. at weeks 0-8 for samples of PEN and PI applied to ¼-inch wide circuit traces. In FIG. 5, adhesion retention was defined relative to the 0 week peel strength value, except for the PEN-1 laminate, in which case the values for weeks 0 through 3 were averaged to define the 100% point. In FIG. 6, there are some missing values. Samples were taken at the missing weekly intervals, but no good measurements resulted. As described previously, data were prone to noise in the testing process, and system, which contributed especially to some readings above 100% in both Figures.

The adhesion of the ¼-inch wide traces (see FIGS. 5 and 6) was less sensitive to ink exposure than that of the narrower traces (see Tables 5 and 6 below). With the circuits with ¼-inch traces, both adhesive-less based PI circuits and the adhesive-based PEN circuits retained about the same percentage of peel strength (see FIGS. 5 and 6) with post-6 week peel retentions varying only between about 80 to 100% (roughly the same considering the noise inherent to this destructive peel technique).

However, with the circuits with fine traces, the failure times of the PI circuits were always shorter than the failure times of the PEN circuits, especially with exposure to high pH ink (1 and 2 weeks versus greater than 8 weeks). In summary, the results show that many varieties of PEN-based circuits survived long ink exposure conditions, which included different PEN film raw material sources and/or manufacturers, different PEN laminate manufacturers, different adhesive formulations including but not limited to modified epoxies and polyester-epoxy blends, and the inclusion or non-inclusion of dyes and flame retardant additives to the adhesive part of the laminate. Moreover, a comparison of FIGS. 5 and 6 also show that pH has very little effect on the circuit traces where the base material comprises a PEN material regardless of the other factors, which is a significant advantage for use in print head flex circuits.

Tables 5 and 6 show the results of testing 3 samples of each type of film. The percentage of the failures, out of 100%, reflects the percentage of the 3 samples that 10 failed. A weekly failure time is provided when one of the three failure percentages (33, 67 and 100%) occurred. As seen in Tables 5 and 6, PEN consistently performed well in the application with inks of both low and high pH showing little variability across the pH range tested. There was not as much of a difference in PEN's performance from PI's at low pH ink exposure, although the PEN variations performed consistently as well if not better than PI. At exposure to higher pH inks, PEN performed much better than PI consistently over the PEN variations.

TABLE 5
Bare Circuit Survival in High pH (pH >8) Ink at 60 deg C.

| PI | | | | | | | | | |
|---|---|---|---|---|---|---|---|---|---|
| (PI) | | | | | | | | | |
| or | | Copper | | | | 33% | | 67% | 100% |
| PEN | Film | Laminate | Adhesive | Dye in | FR in | Failure | | Failure | Failure |
| film | Manuf'r | Manuf'r | Chemistry | Adhesive | Adhesive | Time | | Time | Time |
| PI-1 | 1 | 1 | na | na | Na | 1 | week | 2 weeks | 2 weeks |
| PEN-1 | 1 | 1 | Polyester | yes | Yes | >8 | weeks | | |
| | | | epoxy-1 | | | | | | |
| PEN-5 | 2 | 2 | Modified | no | Yes | >8 | weeks | | |
| | | | epoxy-1 | | | | | | |
| PEN-2 | 1 | 1 | Polyester | yes | No | >8 | weeks | | |
| | | | epoxy-2 | | | | | | |
| PEN-3 | 1 | 1 | Polyester | no | Yes | >8 | weeks | | |
| | | | epoxy-3 | | | | | | |
| PEN-4 | 1 | 1 | Polyester | no | No | >8 | weeks | | |
| | | | epoxy-2 | | | | | | |
| PEN-6 | 1 | 3 | Modified | no | Yes | >7 | weeks | | |
| | | | epoxy-1 | | | | | | |

TABLE 6
Bare Circuit Survival in Neutral/Low pH (pH less than or equal to 7) Ink at 60 deg C.

| PI | | | | | | | | |
|---|---|---|---|---|---|---|---|---|
| (PI) | | | | | | | | |
| or | | Copper | | | | 33% | 67% | 100% |
| PEN | Film | Laminate | Adhesive | Dye in | FR in | Failure | Failure | Failure |
| film | Manuf'r | Manuf'r | Chemistry | Adhesive | Adhesive | Time | Time | Time |
| PI-1 | 1 | 1 | na | na | Na | 2 weeks | >8 wks | >8 wks |
| PEN-1 | 1 | 1 | Polyester | yes | Yes | >8 weeks | | |
| | | | epoxy-1 | | | | | |
| PEN-5 | 2 | 2 | Modified | no | Yes | >8 weeks | | |
| | | | epoxy-1 | | | | | |
| PEN-2 | 1 | 1 | Polyester | yes | No | >8 weeks | | |
| | | | epoxy-2 | | | | | |
| PEN-3 | 1 | 1 | Polyester | no | Yes | >8 weeks | | |
| | | | epoxy-3 | | | | | |
| PEN-4 | 1 | 1 | Polyester | no | No | >8 weeks | | |
| | | | epoxy-2 | | | | | |
| PEN-6 | 1 | 3 | Modified | no | Yes | >7 weeks | | |
| | | | epoxy-1 | | | | | |

The source of the materials in FIGS. 5 and 6 and Tables 5 and 6 are provided below. PI-1 was an adhesive-less PI, and is specifically Kapton-E film, commercially available from E. I. du Pont de Nemours and Company of Wilmington, Del., U.S.A. The film included copper sputtered over a chromium sputtered tie layer and then electroplated up to 35 micron thickness according to U.S. Pat. No. 4,863,808. PEN-1 was a polyester-epoxy adhesive with both a dye and a flame retardant, on which Multek Flexible Circuits Inc., Sheldahl Technical Materials Division (Northfield, Minn.) laminated 1 oz Cu foil with 0.7 mil thick A477 adhesive (called “Polyester-epoxy-1”) to the 1 mil thick PEN film. PEN-2 includes a polyester-epoxy adhesive with a dye, but without a flame retardant, on which Multek Flexible Circuits Inc., Sheldahl Technical Materials Division (Northfield, Minn.) laminated 1 oz Cu foil with 0.7 mil thick A523 adhesive to the 1 mil thick PEN film. The polyester-epoxy blend adhesive is a different formulation than above (thus identified in the Table as “Polyester-epoxy-2”). PEN-3 included a polyester-epoxy adhesive without a dye but with a flame retardant, on which Multek Flexible Circuits Inc., Sheldahl Technical Materials Division (Northfield, Minn.) laminated 1 oz Cu foil with 0.7 mil thick A478 adhesive to the 1 mil thick PEN film (called G1910). The polyester-epoxy blend adhesive is a different formulation than either incorporated into the other Sheldahl laminates above (thus identified in the Table as “Polyester-epoxy-3”). PEN-4 included a polyester-epoxy adhesive without a dye and without a flame retardant. Multek Flexible Circuits Inc., Sheldahl Technical Materials Division (Northfield, Minn.) laminated 1 oz Cu foil with 0.7mil thick A523 adhesive to the 1 mil thick PEN film. The polyester-epoxy blend adhesive is a different formulation than some of the other adhesives (thus identified in the Table as “Polyester-epoxy-2”). PEN-5 included a modified epoxy adhesive with different chemistry than the Sheldahl laminates listed above. There is no dye, but a flame retardant was added to the laminate. This is a laminate like GTS 5670 (available from GTS Flexible Materials Ltd., Berkshire, United Kingdom) laminated 1 oz Cu foil with 1 mil thick adhesive. The differing appearance and properties of the adhesive and Cu foils indicate different raw material manufacturing sources from the laminates made by Multek Flexible Circuits Inc., Sheldahl Technical Materials Division and GTS Flexible Materials Ltd., although the PEN film from these two laminate manufacturers may be the same. PEN-6 from Taiflex Scientific Company, Ltd., Kaohsiang, Taiwan uses a Teonex PEN film (DuPont-Teijin Films™ Teonex® Q83™, available from DuPont Teijin Films US Limited Partnership, in Hopewell, Va., U.S.A.) that has the same appearance as PEN base films made by Multek Flexible Circuits Inc., Sheldahl Technical Materials Division, but with a different copper foil (available from Furukawa Circuit Foil Company, Ltd., located in Imaichi-City, Tochigi-prefecture, Japan) and a different adhesive chemistry (a modified epoxy that has different appearance and properties than the modified epoxy included in the laminate made by GTS Flexible Materials Ltd.). The superior longevity of the bare PEN circuits (bare circuits have metal traces exposed to the environment and are not coated with a cover layer or cover coat) was at least partly attributed to greater potential adhesion retention as a result of physical and chemical bonding differences between the adhesive-based materials than adhesive-less circuits. With the adhesive-based systems adhesion retention will depend on ability of the adhesive and its interfaces to withstand attack from the ink components. Any ink component including moisture that permeates through the base substrate material can potentially attack the adhesive. Just as important, adhesion may be weakened at either or both adhesive-substrate or adhesive-metal interfaces as a result of absorbed moisture or any part of the ink solution that swells the adhesive or the base material thereby creating stress in the metal-substrate stack-up. Interfacial bonds or bonds in the internal bulk structure of the adhesive are susceptible to attack by the ink components. For this reason, it is expected that different adhesive systems used in conjunction with different base materials will have better reliability over others. Copper foil adhesion to the adhesive will also be impacted by copper roughness and surface interface treatments such as Zn—Cr. It is expected that a greater copper roughness or “tooth” will be more reliable than smoother copper because of greater surface area for bonding and Zn—Cr coatings will improve adhesion retention due to galvanic protection of the copper. All of the adhesive-based PEN circuits tested had copper foils in the raw laminates with adhesion, barrier and stabilization treatments, so these are preferred in the invention. However, other current or future developed adhesion, barrier and stabilization treatments are also contemplated. Because of long survival in the tests, adhesives with modified epoxy and polyester epoxy blend chemistries are also preferred, although others are expected to work sufficiently

Unlike the adhesive-based systems, the adhesive-less materials have a Cu-tie coat-substrate stack-up. The adhesive-less materials are not expected to have as good of adhesion retention since the copper-tie coat (chromium, monel, etc.) couple may be susceptible to galvanic corrosion (e.g., chromium is more noble than copper), but are expected to be sufficient for some ink jet applications.

3. Cover coated circuits comparison of those made from polyimide (PI) versus polyethylene naphthalate (PEN) base materials.

Some fine-lined bare circuits with metal traces representative of printer flex product designs described in Example 2 were cover coated with two representative cover coats and exposed to the same accelerated ink environments of 60 deg C. for up to 1000 hours as in Example 1 and 2. The different material types, procedure and failure criteria (includes delamination of cover coat) have been described in Example 2. The cover coat material and process conditions and ink performance summary are listed in Tables 7-9. Tables 7-9 also show the failure time in weeks at which failure in one of three percentages of failure for the three samples tested (33, 67 and 100%). As can be seen, PEN-film base circuits comparatively survived at least as long as PI film based circuits, in most cases longer. With high pH ink, circuits made from all 5 PEN materials that were cover coated with epoxy-acrylic resin material #1 survived longer than the PI based circuits cover coated similarly (see Table 7) and circuits made from 4 out of 5 PEN materials that were cover coated with epoxy-acrylic-resin based material #2 survived longer than the similarly coated PI based circuits (see Table 8). With neutral/low pH ink, all PEN and PI circuits survived the 7-week duration of the test without failures (see Table 9).

TABLE 7
Cover-coated Circuit Survival in High pH (pH >8) Ink at 60 deg C. -
Cover Coat 1.

| | | Copper | | | | 33% | 67% | 100% |
|---|---|---|---|---|---|---|---|---|
| PI (PI) or | Film | Laminate | Adhesive | Dye in | FR in | Failure | Failure | Failure |
| PEN film | Manuf'r | Manuf'r | Chemistry | Adhesive | Adhesive | Time | Time | Time |
| PI-1 | 1 | 1 | na | na | Na | 7 weeks | 7 weeks | >7 weeks |
| PEN-1 | 1 | 1 | Polyester | yes | Yes | >7 weeks | | |
| | | | epoxy-1 | | | | | |
| PEN-5 | 2 | 2 | Modified | no | Yes | >7 weeks | | |
| | | | epoxy-1 | | | | | |
| PEN-2 | 1 | 1 | Polyester | yes | No | >7 weeks | | |
| | | | epoxy-2 | | | | | |
| PEN-3 | 1 | 1 | Polyester | no | Yes | >7 weeks | | |
| | | | epoxy-3 | | | | | |
| PEN-4 | 1 | 1 | Polyester | no | No | >7 weeks | | |
| | | | epoxy-2 | | | | | |

TABLE 8
Cover-coated Circuit Survival in High pH (pH >8) Ink at 60 deg C. -
Cover Coat 2.

| | | Copper | | | | 33% | 67% | 100% |
|---|---|---|---|---|---|---|---|---|
| PI (PI) or | Film | Laminate | Adhesive | Dye in | FR in | Failure | Failure | Failure |
| PEN film | Manuf'r | Manuf'r | Chemistry | Adhesive | Adhesive | Time | Time | Time |
| PI-1 | 1 | 1 | na | na | Na | 5 weeks | 6 weeks | 6 weeks |
| PEN-1 | 1 | 1 | Polyester | yes | Yes | 6 weeks | 6 weeks | 6 weeks |
| | | | epoxy-1 | | | | | |
| PEN-5 | 2 | 2 | Modified | no | Yes | 6 weeks | 6 weeks | 6 weeks |
| | | | epoxy-1 | | | | | |
| PEN-2 | 1 | 1 | Polyester | yes | No | 5 weeks | 5 weeks | 6 weeks |
| | | | epoxy-2 | | | | | |
| PEN-3 | 1 | 1 | Polyester | no | Yes | 6 weeks | 6 weeks | 6 weeks |
| | | | epoxy-3 | | | | | |
| PEN-4 | 1 | 1 | Polyester | no | No | 6 weeks | 6 weeks | 6 weeks |
| | | | epoxy-2 | | | | | |

TABLE 9
Cover-coated Circuit Survival in Neutral/Low pH (pH <7) Ink at 60 deg C. -
either Cover Coat 1 or Cover Coat 2.

| | | Copper | | | | 33% | 67% | 100% |
|---|---|---|---|---|---|---|---|---|
| PI (PI) or | Film | Laminate | Adhesive | Dye in | FR in | Failure | Failure | Failure |
| PEN film | Manuf'r | Manuf'r | Chemistry | Adhesive | Adhesive | Time | Time | Time |
| PI-1 | 1 | 1 | na | na | na | >7 weeks | | |
| PEN-1 | 1 | 1 | Polyester | yes | yes | >7 weeks | | |
| | | | epoxy-1 | | | | | |
| PEN-5 | 2 | 2 | Modified | no | yes | >7 weeks | | |
| | | | epoxy-1 | | | | | |
| PEN-2 | 1 | 1 | Polyester | yes | no | >7 weeks | | |
| | | | epoxy-2 | | | | | |
| PEN-3 | 1 | 1 | Polyester | no | yes | >7 weeks | | |
| | | | epoxy-3 | | | | | |
| PEN-4 | 1 | 1 | Polyester | no | no | >7 weeks | | |
| | | | epoxy-2 | | | | | |

Cover Coat 1 is TF200FR2 cover coat based on epoxy-acrylic resin chemistry, screen printed and cured according to supplier's standard published recommendations (Taiyo America, Inc., Carson City, Nev., U.S.A.). Cover Coat 2 is NPR-5 epoxy-acrylic resin based cover coat, screen printed and cured according to supplier's standard published recommendations (Nippon Polytech Corp., Tokyo, Japan).

The results in Tables 7-9 above show that PEN is a good choice of material for the application. It is good regardless of the type of PEN used. PEN is at least as good as PI, and in many cases it performs better than PI in this application.

4. Capability of PEN circuits to be fabricated with all the required, characteristic ink jet printer flex circuit design features.

Besides the fine lined, cover coated test circuits used to evaluate ink performance in Examples 2, 3, and 5, 1 ML and 2 ML PEN circuits, having all features generally characteristic of printer cartridge circuit designs, were fabricated successfully using all of the various PEN base film laminate materials (PEN-1 through PEN-6). The 1 ML fabrication methods included subtractive etching of copper using a negative photoresist that was accomplished in the same way as was described in Example 2. Patterned removal of PEN and adhesive in order to access backside metal features for terminal connections and to produce spanning conductor features was accomplished by laser ablation. Metal surface cleaning of laser residues was accomplished by a combination of oxygen or oxygen/CF4 plasma, chemical and/or electrolytic (cathodic or anodic) cleaning. All copper is preferred to be plated with electrolytic gold. Cover coats were preferably applied by a screen printing process, but photoimageable cover coats were also applied successfully.

When backside access to front-side metal circuit features is required, following laser ablation (both UV and CO2 types used successfully), the following methods can be used in combination to clean the metal sufficiently for post-plating (e.g., electrolytic gold): plasma (both O2 and O2/CF4 methods used successfully), chemical cleaning with sulfuric-acid-based microetch baths (e.g., persulfate, peroxy-sulfuric successfully used), and electrolytic cleaning (e.g., both sodium and potassium hydroxide based cleaners were successfully used).

Two-metal (2 ML) adhesive-based PEN circuits were also made by laser drilling 30-50 micron diameter vias for frontside to backside circuit layer access, in combination with all the 1 ML process steps described above for patterning metal layers and dielectric features. PEN itself without adhesive was also ablated or etched in order to be able to create vias, backside access pad and spanning conductor features for use in adhesive-less PEN circuit constructions. Chemical etch rates were determined of 50 and 75 micron thick PEN films (Teonex® Q83 film, available from DuPont-Teijin Films US Limited Partnership of Hopewell, Va., U.S.A.) to be as high as 12 micron/minute by measuring weight loss after heated exposure to various monoethanol amine solution concentrations in different basic solutions (NaOH and KOH based). Using a metal mask type of process as described previously has been found to create acceptable PEN sidewall profiles, because both KOH and NaOH have proven effective in chemically etching (isotropic etch at similar etch rates) PI patterns with acceptable sidewall profile in PI flex circuits with this type of masking approach, although the unzipping mechanism (i.e., mechanism of breaking the chemical bonds in a polymer) is different on PI than with PEN.

Direct PEN metallized (chromium tie layer sputtered and electrolytic-plated) adhesive-less PEN material with circa 1 lbs/in adhesion values is available commercially from Multek Flexible Circuits, Inc., Sheldahl Technical Materials Division, located in Northfield, Minn., U.S.A., as an option to adhesive-based laminates provided by them (e.g., see PEN-1 through PEN-4 laminate descriptions). Also, direct PEN metallization by lamination of PEN to Olin Corporation, Brass Division's (located in East Alton, Ill., U.,S.A.) commercially available copper foils as created in a small lamination press gave similar levels of adhesion.

5. THB and biased ink immersion electromigration testing.

To test for the possibility for catastrophic electromigration failures occurring over extended product lifetimes, circuit samples with product-representative minimum, 75 micrometer (nominal) trace width and spaces, with the traces oriented parallel to each other, were fabricated on different base flexible films, both adhesive-less and adhesive-based with different adhesive types (similar to those described in Example 2) and were tested in an accelerated test environment. These circuits were cover coated with the same two materials and with the corresponding processes described in Example 3. The patterned copper trace can be described as a “comb,” such that every other trace is electrically connected together along one side to a large (5 mm square) terminal pad and the adjacent, every-other set of traces are electrically connected to each other along the other side and connected to another large terminal pad. The two pads were soldered to wires connected to an external DC power supply, thereby enabling adjacent traces to be alternately biased, while the circuits were exposed to two separate test environments: a standard accelerated temperature-humidity-bias (THB) stress environment and a bias, ink environment. As a reference, a Japanese patent (referenced earlier, Patent Journal (A) Kokai Patent Application no. HEI 10[1998]-158582)) describes a similar THB test for 500-1000 hours, which results were correlated to a survival time in biased ink immersion testing (similar to the THB test, but instead of an 85C./85% RH, immersion in liquid ink was used: 5 to 19.25 volt range, 144 to 672 hours test duration range, where 2 samples per circuit coating material were evaluated), and which was used to test different cover coat materials on adhesive-less PI circuits.

Likewise in this study, THB JEDEC (conditions of/85% RH/10volts/1000 hours, see EIA/JESD Standard Test Method A-101-B, “Steady State Temperature Humidity Bias Life Test,” Apr. 1997; 5 circuits per laminate material type were evaluated here) and biased ink immersion (conditions of 60 deg C./320 hours/5 volts; 2 circuits per laminate material type were evaluated here) were also used to approximate the environmental exposure in liquid ink of the product accelerated over its lifetime. Gathering results with different circuit material types enabled a relative comparison between materials about electrical performance in an environment closer to the application (circuits exposed to liquid ink rather than to just humidity), which complemented the relative comparison between materials that the THB test provided.

The THB dryout conditioning (after the bias/enviromnental exposure time was completed and just prior to making the post-stress resistance readings) was 48 hours in air (see A-101-B test method description), but the biased ink immersion dry-out condition was for 3 hours at 105 deg C., in order to allow for as much of the absorbed liquid ink ionic and non-ionic volatiles (water and other more volatile ink components) opportunity to escape.

Performing the bias test in ink had as a basis the standard test method for monitoring CAF growth (sometimes called dendrite formation) with temperature-humidity (e.g., 85 deg C./ 85% relative humidity) and bias (1.8 volts and higher) stresses that simulate what real circuits in computers and other electronics applications experience only accelerated in time. In the THB test, however, the dry-out period (48 hours) permits the circuits to return reversibly to their initial, steady-state environmental conditions, as long as dendrites have not formed to bridge the adjacent traces at any point in the comb design. Inherent to base substrate and cover coat materials, the insulation resistance decreases with humidity for the accelerated THB test environment, so the dry-out period allows for the circuits to return to the same steady-state environmental conditions for the post-stress resistance readings and offers the best comparison between initial and final resistance values.

In contrast and inherent to the biased ink immersion test, all ionic constituents in the ink that have been absorbed into the region of the adjacent conductors, but are for example less volatile, are not removed effectively by any dry-out procedure and they contribute to lowering the post dry-out insulation resistance. Therefore, returning of the stressed samples to the same condition as they were initially was impossible, and exact comparisons between post- dry out and pre-stress insulation resistance values could not strictly be made, although the dry-out conditioning procedure used sought to return the circuits to as dry of a steady state environment as they experienced before being immersed in liquid ink before the test. With both the THB and biased ink immersion tests, an ohmimeter accurate and sensitive up to about 10E13 ohm was used to measure both initial and post-dry out insulation resistance values of the circuits at 50 volts of constant bias for 60 seconds.

The failure criteria for both the biased ink immersion and the THB test were set as follows. If individual comb circuits exhibited a much lower post-stress than initial resistance (e.g., low ohms might indicate a short or metal bridge), these circuits have failed either test, but if circuits exhibited (1) high post-stress resistance values, above 10E04 or 10E6 ohms for the biased ink immersion test, or (2) similar resistance, higher or within 1 order of magnitude lower than the pre-stress reading, for the THB test, the circuits successfully passed the test.

For the THB test, all circuits made from all material types passed, because final dry-out resistance was never less than an order of magnitude of the already high (above 10E9 ohms) initial resistance (see Table 10 and 11) and most often was higher than the initial resistance. Thus, all PEN circuits, fabricated by multiple manufacturers (potentially as many as 2 PEN base film sources and definitely 3 laminate manufacturers) with different adhesive chemistries (3 different polyester-epoxy blends and 2 different modified epoxies) and with or without inclusion of dyes or flame retardants performed equally as well as the adhesive-less PI circuits, regardless of which representative cover coat (#1 or #2) was used.

TABLE 10
THB Results for PI and PEN Based Circuits with Cover Coat 1.

| PI | | | | | | |
|---|---|---|---|---|---|---|
| (PI) | | | | | | |
| or | | Copper | | | | Pass |
| PEN | Film | Laminate | Adhesive | Dye in | FR in | or |
| film | Manuf'r | Manuf'r | Chemistry | Adhesive | Adhesive | Fail |
| PI-1 | 1 | 1 | na | Na | Na | Pass |
| PEN-1 | 1 | 1 | Polyester | Yes | Yes | Pass |
| | | | epoxy-1 | | | |
| PEN-5 | 2 | 2 | Modified | No | Yes | Pass |
| | | | epoxy-1 | | | |
| PEN-2 | 1 | 1 | Polyester | Yes | No | Pass |
| | | | epoxy-2 | | | |
| PEN-3 | 1 | 1 | Polyester | No | Yes | Pass |
| | | | epoxy-3 | | | |
| PEN-4 | 1 | 1 | Polyester | No | No | Pass |
| | | | epoxy-2 | | | |
| PEN-6 | 1 | 3 | Modified | No | Yes | Pass |
| | | | epoxy-1 | | | |

TABLE 11
THB Results for PI and PEN Based Circuits with Cover Coat 2.

| PI | | | | | | |
|---|---|---|---|---|---|---|
| (PI) | | | | | | |
| or | | Copper | | | | Pass |
| PEN | Film | Laminate | Adhesive | Dye in | FR in | or |
| film | Manuf'r | Manuf'r | Chemistry | Adhesive | Adhesive | Fail |
| PI-1 | 1 | 1 | na | na | Na | Pass |
| PEN-1 | 1 | 1 | Polyester | yes | Yes | Pass |
| | | | epoxy-1 | | | |
| PEN-5 | 2 | 2 | Modified | no | Yes | Pass |
| | | | epoxy-1 | | | |
| PEN-2 | 1 | 1 | Polyester | yes | No | Pass |
| | | | epoxy-2 | | | |
| PEN-3 | 1 | 1 | Polyester | no | Yes | Pass |
| | | | epoxy-3 | | | |
| PEN-4 | 1 | 1 | Polyester | no | No | Pass |
| | | | epoxy-2 | | | |
| PEN-6 | 1 | 3 | Modified | no | Yes | Pass |
| | | | epoxy-1 | | | |

For the biased ink immersion test, all circuits made from all material types likewise passed (see Table 12 for circuits with Cover Coat 1 and Table 13 for circuits with Cover Coat 2), because the post-stress resistance criteria were met and no electrical shorts or metal were observed during post-stress optical microscope inspections.

TABLE 12
Biased Ink immersion Results for PI and PEN Based Circuits
with Cover Coat. 1.

| PI | | | | | | |
|---|---|---|---|---|---|---|
| (PI) | | | | | | |
| or | | Copper | | | | Pass |
| PEN | Film | Laminate | Adhesive | Dye in | FR in | or |
| film | Manuf'r | Manuf'r | Chemistry | Adhesive | Adhesive | Fail |
| PI-1 | 1 | 1 | na | na | na | Pass |
| PEN-1 | 1 | 1 | Polyester | yes | Yes | Pass |
| | | | epoxy-1 | | | |
| PEN-5 | 2 | 2 | Modified | no | Yes | Pass |
| | | | epoxy-1 | | | |
| PEN-2 | 1 | 1 | Polyester | yes | No | Pass |
| | | | epoxy-2 | | | |

TABLE 13
Biased Ink immersion Results for PI and PEN Based Circuits
with Cover Coat. 2

| PI | | | | | | |
|---|---|---|---|---|---|---|
| (PI) | | | | | | |
| or | | Copper | | | | Pass |
| PEN | Film | Laminate | Adhesive | Dye in | FR in | or |
| film | Manuf'r | Manuf'r | Chemistry | Adhesive | Adhesive | Fail |
| PI-1 | 1 | 1 | na | na | Na | Pass |
| PEN-1 | 1 | 1 | Polyester | yes | Yes | Pass |
| | | | epoxy-1 | | | |
| PEN-5 | 2 | 2 | Modified | no | Yes | Pass |
| | | | epoxy-1 | | | |
| PEN-2 | 1 | 1 | Polyester | Yes | No | Pass |
| | | | epoxy-2 | | | |

The above data show that equivalent performance of many PEN laminate systems with a variety of adhesive and copper foil types versus adhesive-less PI based circuits under the conditions of these two bias tests without any evidence for dendritic shorts. Moreover, PEN's lower ink permeability and moisture absorption than PI's is believed to make PEN circuits superior to PI circuits, although both are acceptable as tested.

6. “Near-Invisible” Splice Strength Testing.

The evaluation of “near invisible” splices of thermoplastic polymeric material flex circuits include two variations of splice. One variation consisted of overlapping two circuits end-to-end along a 24 mm width by 0.040 inches and applying heat and pressure to the overlap area to form a “welded” PEN joint. The second variation consisted of overlapping two circuits end-to-end along a 24 mm width by 0.040 inches with a strip of thermoplastic adhesive between the two circuits at the joint. Heat and pressure were then applied to the overlapped area to reflow the adhesive and bond the two circuits together. In both cases, the joint was “nearly invisible” and did not extend into the functional area of the part.

24 mm circuits tensile testing of adhesive-less and adhesive splice joints was measured with a 10 kg load cell mounted on a “Chatillon” peel test fixture with the substrate attached PEN circuit held in grips anchored to a crossbar. There were 28 adhesive-less samples tested and 46 adhesive samples tested. Individual circuits were pulled at 2 in/min cross head speed until the joint failed. The recorded value represents the maximum pounds of force achieved at the point of failure in pounds of force per inch. All samples failed at the joint. For multiple samples tested, the average maximum force (lb f/in) was 6.22 for the adhesive-less samples and 14.78 for the samples with adhesive added. Samples tested comprised PEN base layers as a suitable thermoplastic polymer for splicing with the understanding that any thermoplastic polymer could be spliced as described. Both variations of the “near invisible” splice performed to acceptable levels for circuit manufacturing where forces typically do not exceed 2 pounds per inch. The “near invisible splice” as tested occupied a 0.040 inch wide strip of material. This narrow strip allowed the splice to be made in a waste area between adjacent parts and allowed 100% part yield as compared to other splice methods, such as for example a butt joint using pressure sensitive tape which would typically cover a much larger area and extend into the actual circuit area thereby making the part a scrap part even if no other defect was present. The adhesive-less splice has the advantage of not requiring any additional material to make the splice, such additional material may not be as compatible with the circuit manufacturing process as the base PEN material. The thermoplastic adhesive splice provides a stronger joint and can be used in applications requiring a higher force.

1. A flex circuit for use in an ink jet printer, the flex circuit comprising a flexible substrate comprising a polyester material layer supporting a plurality of metal conductors adhered along at least a portion of a first side of the substrate, the polyester material comprising a material suitable for use in an ink environment with lower ink permeability and moisture absorption than polyimide material.

2. The flex circuit of claim 1, wherein the polyester material of the substrate comprises PEN.

3. The flex circuit of claim 2, further comprising at least one opening provided through the PEN layer for providing access to at least one conductor.

4. The flex circuit of claim 3, further comprising a metal access pad adhered on the first side of the PEN substrate layer with the plurality of metal conductors, the metal access pad being accessible from a second side of the PEN substrate layer through a patterned opening through the PEN substrate layer, and wherein at least one metal conductor is also accessible from the second side of the PEN substrate layer by way of another opening through the PEN substrate layer.

5. The flex circuit of claim 3, further comprising at least one metal conductor adhered along at least a portion of a second side of the PEN substrate layer and that is electrically connected through a metal via extending through the PEN substrate layer to at least one of the metal conductors on the first side of the PEN substrate layer.

6. The flex circuit of claim 2, 4 or 5, further comprising an adhesive layer between the PEN substrate layer and at least one of the metal conductors for adhering them together.

7. The flex circuit of claim 2, 4, or 5, wherein at least one of the metal conductors is adhered to the PEN substrate layer without an adhesive layer in between.

8. A method of making a flex circuit for use in an ink jet printer, the method comprising the steps of providing a flexible substrate including a polyester material layer and adhering a plurality of metal conductors to one surface of the substrate, wherein the polyester material is suitable for use in an ink environment with lower ink permeability and moisture absorption than polyimide material.

9. The method of claim 8, wherein the polyester material of the substrate comprises PEN.

10. The method of claim 8, further comprising the step of patterning at least one opening through the PEN layer for providing access to at least one conductor.

11. The method of claim 10, further comprising the step of adhering a metal access pad on the first side of the PEN substrate layer along with the plurality of metal conductors, the metal access pad being accessible from a second side of the PEN substrate layer through a first opening patterned through the PEN substrate layer, and patterning a second opening through the PEN substrate layer so that at least one metal conductor is also accessible from the second side of the PEN substrate layer by way of the second opening.

12. The method of claim 10, further comprising the step of adhering at least one metal conductor along at least a portion of a second side of the PEN substrate layer and electrically connecting the metal conductor on the second side by way of a metal via extending through the opening of the PEN substrate layer to at least one of the metal conductors on the first side of the PEN substrate layer.

13. The method of claim 10, further comprising the steps of providing a laminate of the PEN substrate layer and an adhesive layer, patterning the laminate to provide at least one access opening through the laminate, adhering a metal layer to the PEN substrate layer by way of the adhesive layer, and then patterning the metal layer to create the plurality of metal conductors.

14. The method of claim 9, 11 or 12, further comprising the step of providing an adhesive layer between the PEN substrate layer and at least one of the metal conductors for adhering them together.

15. The method of claim 9, 11, or 12, wherein at least one of the metal conductors is adhered to the PEN substrate layer without an adhesive layer in between.

16. A print head for use in an ink jet printer comprising a printer and an ink cartridge and a flex circuit connected electrically to the IC, the flex circuit comprising a flexible substrate comprising a polyester material layer supporting a plurality of metal conductors adhered along at least a portion of the substrate, the polyester material comprising a material suitable for use in an ink environment with lower ink permeability and moisture absorption than polyimide material.

17. The print head of claim 16, wherein the polyester material of the substrate comprises PEN.

18. The print head of claim 17, further comprising at least one opening provided through the PEN layer for providing access to at least one conductor.

19. A method of joining a plurality of flex circuits together in series comprising the steps of:
providing a plurality of unconnected flex circuits, each having a flexible substrate including a thermoplastic polymer material layer, wherein the thermoplastic polymer material is suitable for use in an ink environment with lower ink permeability and moisture absorption than polyimide material, and each flex circuit further having a plurality of metal conductors adhered to one surface of the substrate; and
splicing one flex circuit to a second flex circuit by overlapping at least a portion of the first and second flex circuits together and applying heat and pressure sufficient to thermally bond the first and second flex circuits together in series.

20. The method of claim 19, wherein the thermoplastic polymer material of the substrate comprises a polyester.

21. The method of claim 19, wherein the thermoplastic polymer material of the substrate comprises PEN.

22. The method of claim 19, further comprising the step of inserting a strip comprising an adhesive on the overlapped portion between the first flex circuit and the second flex circuit prior to thermally bonding the first and second flex circuits together.

23. The method of claim 19, wherein the first flex circuit is combined with one or more additional flex circuits having the thermoplastic polymer material substrate layer in common.

24. The method of claim 23, wherein the thermoplastic polymer material of the substrate comprises a polyester.

25. The method of claim 23, wherein the thermoplastic polymer material of the substrate comprises PEN.

26. A method of joining a plurality of flex circuits together in series comprising the steps of:
providing a plurality of unconnected flex circuits, each having a flexible substrate including a polymer material layer, wherein each flex circuit further includes a pattern of metal conductors adhered to one surface of the substrate;
overlapping an edge portion of the flexible substrate outside of the pattern of metal conductors of one flex circuit with an edge portion of the flexible substrate outside of the pattern of metal conductors of another flex circuit;
positioning a strip comprising a thermally active adhesive within an overlapped portion between the first flex circuit and the second flex circuit; and
splicing one flex circuit to a second flex circuit by applying heat and pressure sufficient to thermally bond the first and second flex circuits together in series.

27. The method of claim 26, wherein the polymer material layer of the substrate comprises polyimide.

28. The method of claim 26, wherein the polymer material layer comprises a thermoplastic polymer and the splicing step further comprises thermally bonding the flexible layers together along with the thermally active adhesive.

29. The method of claim 28, wherein the polymer material layer comprises PEN.
